(19) United States
(12) Patent Application Publication
(10) Pub. No.: US 2005/0034677 A1
(43) Pub. Date: Feb. 17, 2005

(54) Aquarium for transgenic fluorescent fish

(76) Inventors: Alan Blake, Austin, TX (US); Richard Crockett, New Haven, CT (US)

Correspondence Address: COHEN SAKAGUCHI & ENGLISH LLP, 2040 MAIN STREET, 9TH FLOOR, IRVINE, CA, 92614, US

(21) Appl. No.: 10/627,176

(22) Filed: Jul. 25, 2003

(51) Int. Cl. A01K 63/06

(52) U.S. Cl. 119/266

(57) ABSTRACT

An aquarium comprises a tank and an excitation light source which is configured to emit light at a wavelength selected to be optimal for causing a transgenic ornamental fish to fluoresce, wherein the ornamental fish expresses one or more fluorescent proteins at a level sufficient such that said fish fluoresces upon exposure to the excitation light source. The aquarium may further comprise one or more of the following: a transgenic fluorescent fish, a second light source, gravel or other ornamental objects, a plant or a water conditioning system. The transgenic fluorescent fish may comprise one or more chimeric fluorescence genes encoding one or more fluorescent proteins.

### FIELD OF THE INVENTION

The present invention relates generally to aquariums and more particularly to aquariums for transgenic fluorescent fish.

### BACKGROUND OF THE INVENTION

Aquariums are typically comprised of a tank which can be filled with water, a system for maintaining the condition of the water (e.g. filter, aeration pump, heater), and ornamental features such as plants, gravel, rocks and curios. The tank may be of any shape such as rectangular tanks or round bowls, and the sides of the tank are typically transparent. The aquarium may also be provided with a lighting system.

Various fish tank lighting systems have been previously shown and described. For example, U.S. Pat. Nos. 3,836,765 and 5,089,940 describe lighting systems comprising a hood and a lighting fixture housed in the hood. The hood is configured to rest on the top of an aquarium tank.

PCT Application Serial No. PCT/SG99/0079, International Publication No. WO 00/49150, by Gong et al., discloses many different types of transgenic fluorescent fish and various methods of producing such fish. For instance, zebra fish transfected with green fluorescent protein (GFP) genes isolated from a jelly fish (Aqueoria Victoria) are described in detail. In addition, numerous modified mutants of GFP are disclosed, for example, various colors and mammalian optimized mutants are described. Fluorescence is the emission of light resulting from the absorption of excitation light. For example, GFP has a maximum excitation at a wavelength of 395 nm and emits green fluorescence at a wavelength (maximum) of 508 nm. The transgenic ornamental fish described in PCT/SG99/0079 are genetically engineered by introducing genes into the fish which express fluorescent proteins. By positioning the fluorescent gene under the control of a specific promoter, the fluorescent protein genes may be used to express the fluorescent proteins in specific tissues, such as in skin tissue, muscle tissue or bone tissue. Gong et al. disclose fish containing numerous different fluorescent proteins, including green fluorescent protein (GFP), enhanced green fluorescent protein (eGFP), yellow fluorescent protein (YFP), enhanced yellow fluorescent protein (eYFP), blue fluorescent protein (BFP), enhanced blue fluorescent protein (eBFP), cyan fluorescent protein (CFP) and enhanced cyan fluorescent protein (eCFP). There are also various colors of coral fluorescent proteins (available from BD Biosciences Clontech) which are suitable for creating transgenic ornamental fish.

All patents and patent applications referenced in this application are hereby incorporated by reference herein in their entirety.

### SUMMARY OF THE INVENTION

The aquarium kit of the present invention is particularly configured for the display of transgenic fluorescent ornamental fish. The aquarium comprises a tank for containing a volume of water and an excitation light source which is configured to emit light at a wavelength selected to cause a transgenic fluorescent ornamental fish to fluoresce. The ornamental fish may be a transgenic fish comprising one or more chimeric fluorescence genes which expresses one or more fluorescent proteins at a level sufficient such that the fish fluoresces upon exposure to the excitation light source.

In addition, the aquarium kit may comprise an ornamental fish which expresses one or more fluorescent proteins at a level sufficient such that said fish fluoresces upon exposure to the excitation light source. The ornamental transgenic fish may comprise one or more fluorescent proteins, including for example: GFP, eGFP, BFP, eBFP, YFP, eYFP, CFP, eCFP, coral fluorescent protein, or bio-luminescent proteins such as luciferase. The ornamental transgenic fish may be any variety of aquatic animal, including without limitation, zebrafish, medaka, goldfish, carp, koi, tilapia, glassfish, catfish, angel fish, discus, eel, tetra, goby, gourami, guppy, Xiphophorus, hatchet fish, Molly fish, or pangasius.

### BRIEF DESCRIPTION OF THE DRAWINGS

FIG. 1 is a perspective view of an aquarium kit in accordance with the present invention.

FIG. 2 is a bottom view of the housing and lighting module of FIG. 1.

FIG. 3 is a chart of the excitation spectra and emission spectra for various RCFPs.

FIG. 4 is another aquarium kit in accordance with the present invention.

### DETAILED DESCRIPTION OF THE INVENTION

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

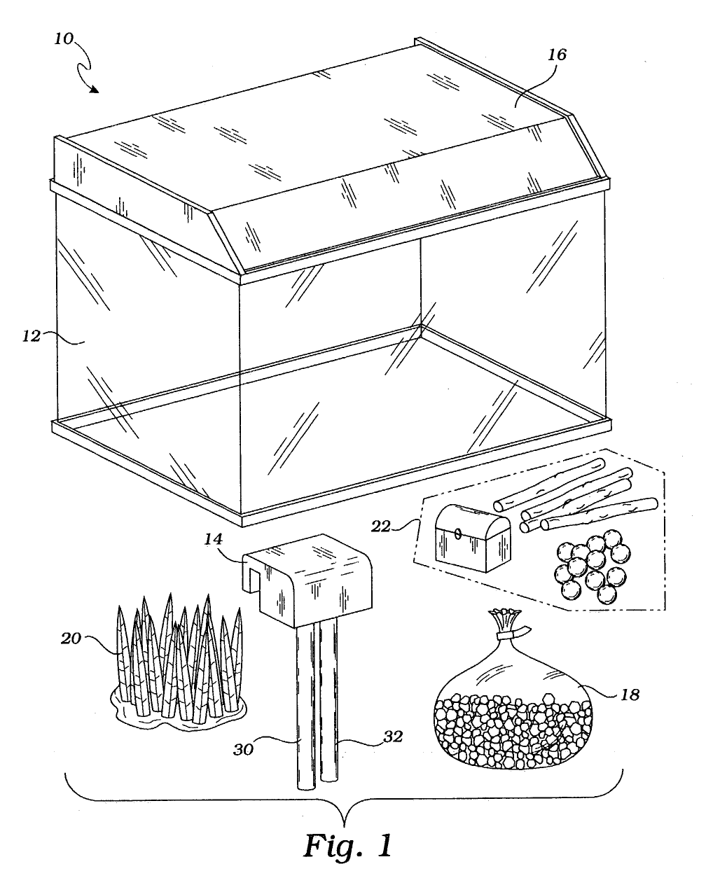

Referring to FIG. 1, the aquarium kit 10 of the present invention comprises a tank 12, a water conditioning system 14, and a lighting module 16. The aquarium kit also comprises various ornamental features such as gravel 18, plants 20 and curios 22. The water condition system 14 may comprise a filter element 30 a heating element 32 and an aeration pump (not shown). The light may be a fluorescent light, a blue light, an ultraviolet light (black light), a xenon lamp, light emitting diode (LED) or other suitable excitation light source. In addition, the aquarium kit 10 may have any combinations of the above lights, for example, an ultraviolet light and a blue light.

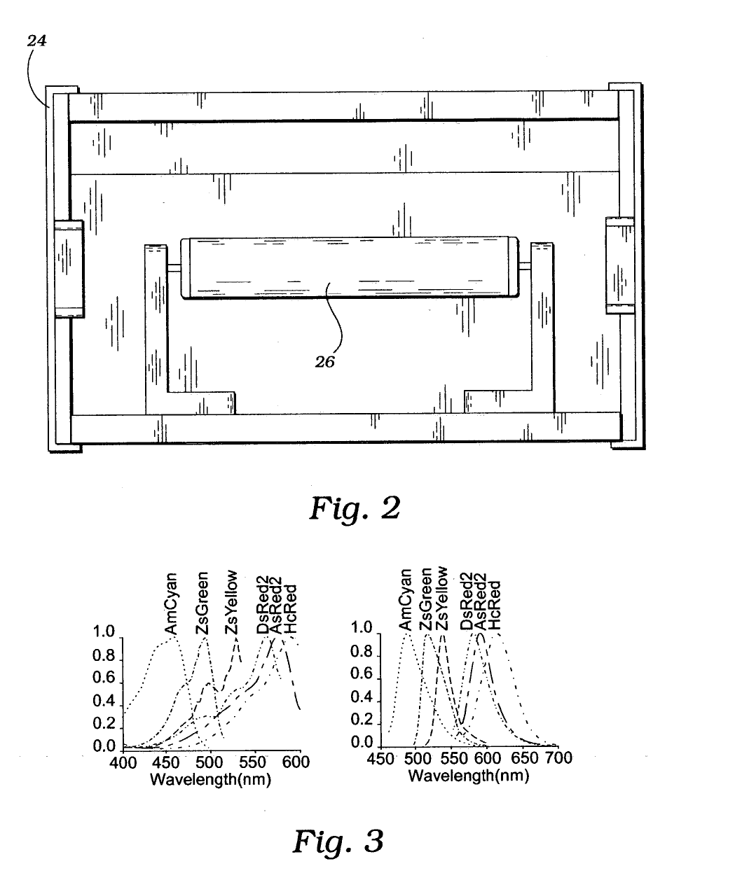

Turning to FIG. 2, the lighting module 16 comprises a housing 24 and an excitation light source 26. The housing 24 is configured to rest on the edge of the top of the tank 12. The housing 24 may be designed to cover all or just a portion of the open top of the tank 12. The excitation light source 26 is mounted to the housing 24. Alternatively, the excitation light source 26 may attach to any part of the tank 12, including the walls of the tank 12, the top edge of the tank 12, or even inside the tank 12 as part of a curio 22 (for example a translucent or transparent rock with an excitation light inside). The excitation light 26 is specifically configured to have an emission spectra such that it will be optimal for causing an ornamental fish to fluoresce wherein the ornamental fish expresses one or more fluorescent proteins at a level sufficient to be visible to the naked eye upon exposure to the excitation light source.

Fluorescent materials fluoresce upon exposure to excitation light over a range (spectrum) of excitation wavelengths and similarly emit light over a spectrum of wavelengths. The excitation spectra and emission spectra for various RCFPs are shown in FIG. 3. Table 1 below lists the maximum excitation and emission wavelengths for various RCFPs.

TABLE 1
Maximum Excitation and Emission Wavelengths for RCFPs

| RCFP | Excitation max (nm) | Emission max (nm) |
|---|---|---|
| AmCyan1 | 458 | 489 |
| ZsGreen1 | 493 | 505 |
| ZsYellow1 | 529 | 539 |
| DsRed2 | 563 | 582 |
| DsRed-Express | 557 | 579 |
| AsRed2 | 576 | 592 |
| HcRed1 | 588 | 618 |

Referring to Table 1 and FIG. 3, it can be seen that DsRed2 has a maximum excitation at a wavelength of 563 nm. This means that an excitation light that emits a high intensity of light at 563 nm will optimally cause RCFP to fluoresce. Therefore, because the wavelength at which RCFP has a maximum excitation is also in the visible range of light, the excitation light will be visible as well as the emitted fluorescent light thereby reducing the relative brightness of the emitted light. Generally, this will not be optimal for vieiwing these fluorescent fish. A chart of visible light is shown in Table 2

TABLE 2
Chart of Colors of Visible Light
Colors of Visible Light

| WAVELENGTH (nm) | PERCEIVED COLOR |
|---|---|
| ˜390 | Violet |
| ˜440 | Blue |
| ˜500 | Green |
| ˜580 | Yellow |
| ˜650 | Red |

Accordingly,light such as a black light which emits ultraviolet light which is at a wavelength below the visible spectrum will also cause RCFP to fluoresce but not as efficiently because it is not at the optimal wavelength. However, for viewing a fluorescent transgenic fish, the black light will generally be preferable because the emitted fluorescent light in the visible spectrum will not be outshined by the excitation light. In order to select an excitation light source which is optimal for viewing a transgenic ornamental fish, the light source must emit light at a wavelength and an intensity that it causes the fish to fluoresce, but the source light should also minimize its emission in the visible spectrum in order to reduce background light. The proper source light maybe chosen by knowing the excitation and emission spectrum of the particular fluorescent protein(s) present in the transgenic fish and reference to the visible light spectrum. The light source 26 may be activated in any number of ways, including the manual light switch, a push-button toggle, an infra-red remote, a radio frequency remote, an internal or external motion sensor, or a chemical or thermal activator. The light source 26 may also operate in a variety of modes such as fading and transition modes, timer modes or light sensing modes.

In order to enhance the appearance of the transgenic fluorescent fish, the kit may further comprise light filters in or on the tank to block light outside the wavelength of the emission spectra of the particular fluorescent proteins in the transgenic fluorescent fish. The appearance of the fluorescent fish could also be enhanced using mirrors, one-way films, wavelength specific or polarizing films, specially angled walls of the tank or the use of special materials within the tank such as reflective mica rocks or such.

In addition, the aquarium kit 10 may further comprise multiple excitation light sources 26 wherein the lights may emit different wavelengths, different intensities or different types of light. The tank 12 may have physical separators to maintain certain fish in different areas of the tank 12 that are lit by the different light sources 26.

The gravel 18, plants 20 and curios 22 may also be fluorescent to augment the appearance of the aquarium kit 10. For example, the plants 20 may be transgenic or other specialty plants which are fluorescent. The curios 22 can be small items such as a miniature treasure chest, marbles, artificial or actual marine objects like coral, rocks or sticks.

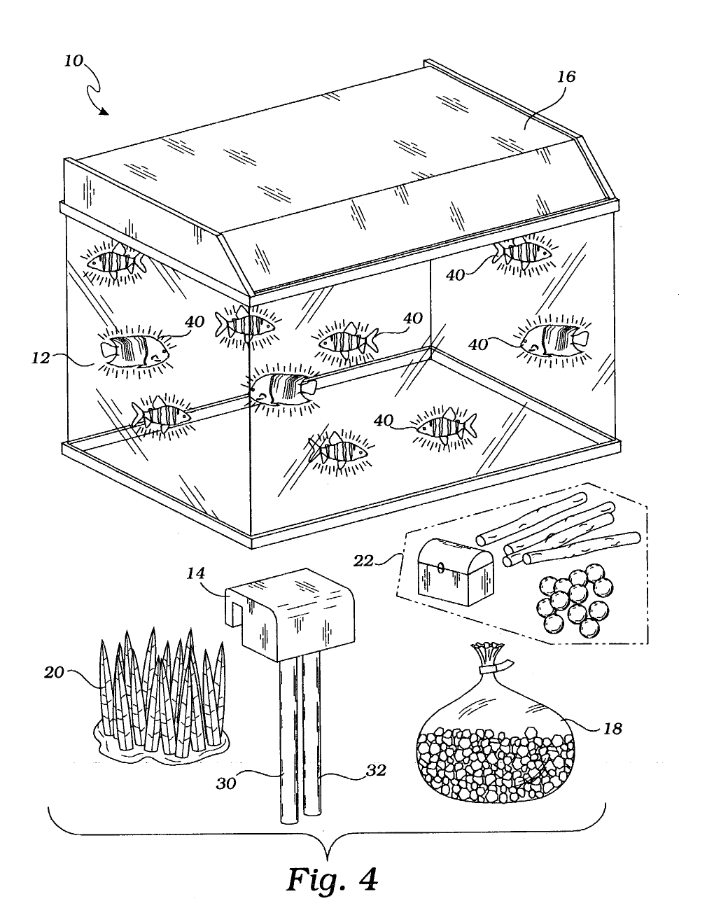

The aquarium kit 10 may also include the transgenic ornamental fish 40 as shown in FIG. 4. Transgenic ornamental fish and the method of producing them are described in detail in PCT Application Serial No. PCT/SG99/0079, and therefore only a general description will be included herein. Generally, a transgenic ornamental fish is produced by inserting a foreign gene which codes for a fluorescent protein into the genome of the host fish. Typically, the fluorescent gene is operatively linked to an endogenous promoter in the fish such that activation of the promoter causes expression of the fluorescent protein coded by the fluorescent gene. A chimeric fluorescent gene comprises a promoter operatively linked to a heterologous gene. For example, a chimeric fluorescent gene can comprise a promoter of a zebrafish operatively linked to a GFP or other fluorescent gene.

A stable transgenic ornamental fish line may be obtained by producing an ornamental transgenic fish comprising one or more chimeric fluorescence genes positioned under the control of a promoter such that the fish expresses one or more fluorescent proteins encoded by the fluorescence genes at a level sufficient that the fish fluoresces upon exposure to an excitation light source. The transgenic fish is then bred with a second fish to obtain offspring. Finally, a stable transgenic fish line that expresses the fluorescent proteins is selected from the offspring. The stable transgenic fish line may then be used to breed large numbers of ornamental fluorescent transgenic fish.

1. An aquarium kit for fluorescent ornamental fish comprising:
a tank; and
an excitation light source, wherein said light source is mountable on said tank and said light source is configured to emit light at a wavelength selected to be optimal for causing an ornamental fish to fluoresce, wherein said ornamental fish expresses one or more fluorescent proteins at a level sufficient such that said fish fluoresces upon exposure to said excitation light source.

2. The aquarium kit of claim 1 wherein said light source is a blue light, a fluorescent light or an ultraviolet light.

3. The aquarium kit of claim 1 further comprising an ornamental fish which expresses one or more fluorescent proteins at a level sufficient such that said fish fluoresces upon exposure to said excitation light source.

4. The aquarium kit of claim 3 wherein said ornamental fish is a transgenic fish comprising one or more chimeric fluorescence genes encoding said one or more fluorescent proteins.

5. The aquarium kit of claim 4 wherein said light source is a blue light, a fluorescent light or an ultraviolet light.

6. The aquarium kit of claim 4 wherein said ornamental fish comprises a GFP.

7. The aquarium kit of claim 4 wherein said ornamental fish comprises an EGFP.

8. The aquarium kit of claim 4 wherein said ornamental fish comprises a BFP.

9. The aquarium kit of claim 4 wherein said ornamental fish comprises a coral fluorescent protein.

10. The aquarium kit of claim 4 wherein said ornamental fish comprises a EBFP.

11. The aquarium kit of claim 4 wherein said ornamental fish comprises a YFP or EYFP.

12. The aquarium kit of claim 4 wherein said ornamental fish comprises a CFP or ECFP.

13. The aquarium kit of claim 4 wherein said ornamental fish is a stable transgenic fish line obtained by a method comprising the steps of:
(a) obtaining an ornamental transgenic fish comprising one or more chimeric fluorescence genes positioned under the control of a promoter, wherein the transgenic fish expresses one or more fluorescent proteins encoded by the one or more fluorescence genes at a level sufficient such that said fish fluoresces upon exposure to an excitation light source; and
(b) breeding the ornamental transgenic fish with a second fish to obtain offspring; and
(c) selecting from said offspring a stable transgenic line that expresses one or more fluorescent proteins.

14. The aquarium kit of claim 4 wherein the ornamental transgenic fish is a transgenic zebrafish, medaka, goldfish, carp, koi, loach, tilapia, glassfish, catfish, angel fish, discus, eel, tetra, goby, gourami, guppy, Xiphophorus, hatchet fish, Molly fish, or pangasius.

15. The aquarium kit of claim 13 wherein the ornamental transgenic fish is a transgenic zebrafish, medaka, goldfish, carp, koi, loach, tilapia, glassfish, catfish, angel fish, discus, eel, tetra, goby, gourami, guppy, Xiphophorus, hatchet fish, Molly fish, or pangasius.

16. The aquarium kit of claim 13 wherein the second fish is a zebrafish, medaka, goldfish or carp, koi, loach, tilapia, glassfish, catfish, angel fish, discus, eel, tetra, goby, gourami, guppy, Xiphophorus, hatchet fish, Molly fish, or pangasius.

17. The aquarium kit of claim 15 wherein the second fish is a zebrafish, medaka, goldfish or carp, koi, loach, tilapia, glassfish, catfish, angel fish, discus, eel, tetra, goby, gourami, guppy, Xiphophorus, hatchet fish, Molly fish, or pangasius.

18. The aquarium kit of claim 1 further comprising a second excitation light source which emits light of different wavelength than said excitation light source.

19. The aquarium of claim 17 wherein said first excitation light source is located on a first side of said tank and said second excitation light source is located on the opposite side of said tank.

20. The aquarium kit of claim 3 wherein said ornamental transgenic fish expresses more than one fluorescent protein and said fluorescent proteins have different colors.

21. The aquarium kit of claim 3 wherein said tank comprises one or more dividers which divide said tank into two or more chambers.

22. The aquarium kit of claim 1 wherein said fish is bio-luminescent.

23. The aquarium kit of claim 3 wherein said fish is bio-luminescent.

24. The aquarium kit of claim 1 further comprising one or more of gravel, a water heating element, a plant and an aeration unit.

25. An aquarium kit for fluorescent ornamental fish comprising:
a tank;
an ornamental fish which expresses one or more fluorescent proteins at a level sufficient such that said fish fluoresces upon exposure to an excitation light source;
an excitation light source, wherein said light source is mountable on said tank and said light source is configured to emit light at a wavelength which excites said one or more fluorescent proteins.

26. The aquarium kit of claim 24 wherein said light source is a blue light, a fluorescent light or an ultraviolet light.

27. The aquarium kit of claim 24 wherein said ornamental fish is a transgenic fish comprising one or more chimeric fluorescence genes encoding said one or more fluorescent proteins.

28. The aquarium kit of claim 27 wherein said light source is a blue light, a fluorescent light or an ultraviolet light.

29. The aquarium kit of claim 27 wherein said ornamental fish comprises a GFP.

30. The aquarium kit of claim 27 wherein said ornamental fish comprises an EGFP.

31. The aquarium kit of claim 27 wherein said ornamental fish comprises a BFP.

32. The aquarium kit of claim 27 wherein said ornamental fish comprises a coral fluorescent protein.

33. The aquarium kit of claim 27 wherein said ornamental fish comprises a EBFP.

34. The aquarium kit of claim 27 wherein said ornamental fish comprises a YFP or EYFP.

35. The aquarium kit of claim 27 wherein said ornamental fish comprises a CFP or ECFP.

36. The aquarium kit of claim 27 wherein said ornamental fish is a stable transgenic fish line obtained by a method comprising the steps of:
(a) obtaining an ornamental transgenic fish comprising one or more chimeric fluorescence genes positioned under the control of a promoter, wherein the transgenic fish expresses one or more fluorescent proteins encoded by the one or more fluorescence genes at a level sufficient such that said fish fluoresces upon exposure to an excitation light source; and
(b) breeding the ornamental transgenic fish with a second fish to obtain offspring; and
(c) selecting from said offspring a stable transgenic line that expresses one or more fluorescent proteins.

37. The aquarium kit of claim 27 wherein the ornamental transgenic fish is a transgenic zebrafish, medaka, goldfish, carp, koi, loach, tilapia, glassfish, catfish, angel fish, discus, eel, tetra, goby, gourami, guppy, Xiphophorus, hatchet fish, Molly fish, or pangasius.

38. The aquarium kit of claim 36 wherein the ornamental transgenic fish is a transgenic zebrafish, medaka, goldfish, carp, koi, loach, tilapia, glassfish, catfish, angel fish, discus, eel, tetra, goby, gourami, guppy, Xiphophorus, hatchet fish, Molly fish, or pangasius.

39. The aquarium kit of claim 36 wherein the second fish is a zebrafish, medaka, goldfish or carp, koi, loach, tilapia, glassfish, catfish, angel fish, discus, eel, tetra, goby, gourami, guppy, Xiphophorus, hatchet fish, Molly fish, or pangasius.

40. The aquarium kit of claim 37 wherein the second fish is a zebrafish, medaka, goldfish or carp, koi, loach, tilapia, glassfish, catfish, angel fish, discus, eel, tetra, goby, gourami, guppy, Xiphophorus, hatchet fish, Molly fish, or pangasius.

41. The aquarium kit of claim 25 further comprising a second excitation light source which emits light of different wavelength than said excitation light source.

42. The aquarium of claim 40 wherein said first excitation light source is located on a first side of said tank and said second excitation light source is located on the opposite side of said tank.

43. The aquarium kit of claim 25 wherein said ornamental transgenic fish expresses more than one fluorescent protein and said fluorescent proteins have different colors.

44. The aquarium kit of claim 25 wherein said tank comprises one or more dividers which divide said tank into two or more chambers.

45. The aquarium kit of claim 25 wherein said fish is bio-luminescent.

46. The aquarium kit of claim 25 further comprising gravel, a water heating element, a plant and an aeration unit.
